(19) United States
(12) Patent Application Publication
(10) Pub. No.: US 2011/0064466 A1
(43) Pub. Date: Mar. 17, 2011

(54) IMAGE FORMING APPARATUS

(75) Inventor: Yasuyuki Inada, Toyohashi-shi (JP)

(73) Assignee: Konica Minolta Business Technologies, Inc., Tokyo (JP)

(21) Appl. No.: 12/881,650

(22) Filed: Sep. 14, 2010

(30) Foreign Application Priority Data
Sep. 17, 2009 (JP) 2009-215330

(51) Int. Cl. G03G 15/01; G03G 15/16

(52) U.S. Cl. 399/121; 399/299; 399/302

(57) ABSTRACT

In an image forming apparatus comprising an intermediate transfer belt (4) in a form of endless loop stretched over a plurality of stretch roller to move around, a plurality of photo conductors (9) aligned along the intermediate transfer belt, a plurality of primary transfer rollers (6Y) which respectively opposes to the photoconductors and is pressed against the photoconductor with interposition of the intermediate transfer belt to form a nip, and a power source for applying a voltage to the primary transfer rollers, the primary transfer rollers (6Y) being arranged to be shifted with reference to the photoconductors (9) in the moving direction of the intermediate transfer belt (4), a shifted amount (D) of at least one of the primary transfer rollers (6Y) with reference to the photoconductor (9) is different from that of another primary transfer roller with reference to the respective photoconductors.

This application is based on application No. 2009-215330 filed in Japan, the contents of which are hereby incorporated by reference.

### FIELD OF THE INVENTION

Present invention relates an image forming apparatus.

### BACKGROUND ART

The so called tandem type color image forming apparatuses in which a plurality of photoconductors of different image forming colors are aligned along a moving direction of an intermediate transfer belt stretched over a plurality of rollers are widely used. Primary transfer rollers are respectively provided in opposing to the photoconductors with interposition of the intermediate transfer belt. A bias voltage is applied between the photoconductor and the primary transfer roller to transfer a toner image formed on the photoconductor to the intermediate transfer belt, and therefore transfer current flows from the primary transfer roller to the photoconductor.

In such image forming apparatus, it is desired that the plurality of primary transfer rollers share a power source applying a bias voltage to reduce a cost. JP-2001-255761-A describes an invention with a common power source in which primary sides of primary transfer rollers are connected via a zener diode to each other to optimize respective transfer current from the primary transfer roller to the photoconductor. Further, JP-2004-258432-A describes an invention with a resisters inserted in the primary side of the primary transfer rollers respectively.

Moreover, a need for downsizing of an image forming apparatus is large. If a tandem type color image forming apparatus is downsized, a distance between the primary transfer roller and stretch rollers on which the intermediate transfer belt is wound get smaller. Since the intermediate transfer belt conducts electricity slightly, a current can leak out from the primary transfer roller via the intermediate transfer belt to the stretch roller, in case that the distance between the primary transfer roller and the stretch roller is smaller. Then, the transfer current at the photoconductor adjacent to the stretch roller is reduced, and therefore it causes a problem that the toner image is not enough transferred to the intermediate transfer belt.

### SUMMARY OF THE INVENTION

In view of the above problems, an object of the present invention is to provide a image forming apparatus in which primary transfers from a plurality of photoconductors to a intermediate transfer belt is respectively conducted appropriately.

In order to achieve the objects of the present invention, there is provided an image forming apparatus comprising an intermediate transfer belt in a form of endless loop stretched over a plurality of stretch roller to move around, a plurality of photo conductors aligned along the intermediate transfer belt, a plurality of primary transfer rollers which respectively opposes to the photoconductors and is pressed against the photoconductor with interposition of the intermediate transfer belt to form a nip, and a power source for applying a voltage to the primary transfer rollers, wherein the primary transfer rollers are arranged to be shifted with reference to the photoconductors in the moving direction of the intermediate transfer belt, and a shifted amount of at least one of the primary transfer rollers with reference to the photoconductor is different from that of another primary transfer roller with reference to the respective photoconductors.

In the image forming apparatus according to the present invention, a shifted amount of the primary transfer roller adjacent to the stretch roller with reference to the photoconductor may be different from that of another primary transfer roller with reference to the photoconductor.

In the image forming apparatus according to the present invention, at least one of the stretch rollers to which the primary transfer roller is adjacent may oppose to a secondary transfer roller.

In the image forming apparatus according to the present invention, the shifted amount of the primary transfer roller adjacent to the stretch roller with reference to the photoconductor may be varied depending on at least one of an environmental condition and an operation speed of the image forming apparatus.

In the image forming apparatus according to the present invention, in case that the intermediate transfer belt have a surface resistivity of 1×10⁸−1×10¹² ohms/sq, the distance between the stretch roller and the primary transfer roller in the moving direction of the intermediate transfer roller preferably is equal to or less than 80 mm.

In the image forming apparatus according to the present invention, the primary transfer roller preferably has a resistance between its surface and its metal core equal to or less than 5×10⁶ ohms.

In the image forming apparatus according to the present invention, all of the primary transfer rollers may be connected to the power source in parallel. Alternatively, the power sources may be independently provided one each for the primary transfer rollers, and the output voltage of the power sources may be fixed.

### BRIEF DESCRIPTION OF THE DRAWINGS

These and other objects and features of the present invention will become apparent from the following description taken in conjunction with the preferred embodiments thereof with reference to the accompanying drawings, in which:

FIG. 1 is a schematic mechanical configuration diagram of an image forming apparatus as first embodiment of the present invention;

FIG. 2 is a detailed configuration diagram of the primary transfer portion of the image forming apparatus in FIG. 1;

FIG. 3 is a schematic electrical configuration diagram of the image forming apparatus in FIG. 1;

FIG. 4 is an equivalent circuit diagram to the FIG. 3;

FIG. 5 is a chart showing a relationship between shift amount of the primary transfer roller and transfer current in the photoconductor in the image forming apparatus in FIG. 1; and

FIG. 6 is a schematic electrical configuration diagram of the image forming apparatus as second embodiment of the present invention.

### DETAILED DESCRIPTION OF THE PREFERRED EMBODIMENT

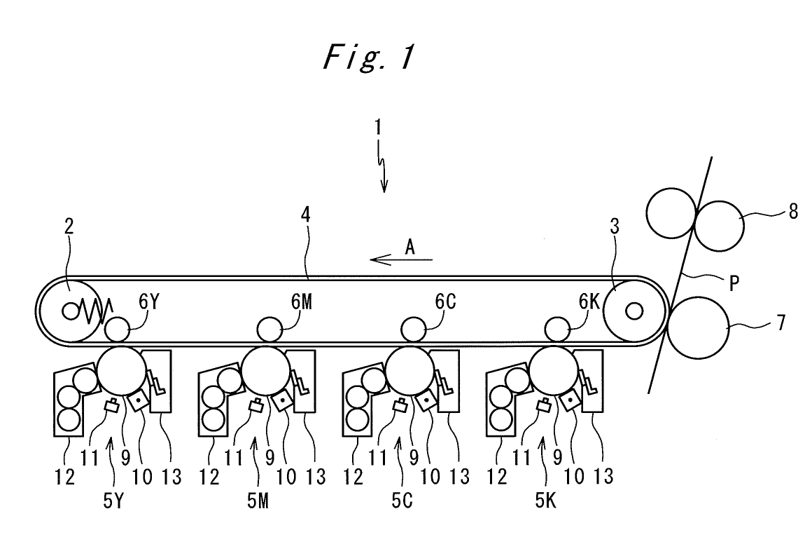

Hereinafter, embodiments of the present invention will be described referring to the drawings. FIG. 1 shows an outline of an image forming apparatus 1 as first embodiment of the present invention.

The image forming apparatus 1 has a endless loop-like intermediate transfer belt 4 stretched over stretch rollers 2, 3 so as to move around in a direction of the arrow A, four image forming portions 5Y, 5M, 5C, 5K respectively developing toner images with toner in color of yellow, cyan, magenta or black, primary transfer rollers 6Y, 6M, 6C, 6K primary transfer respectively the toner images developed by the image forming portions 5Y, 5M, 5C, 5K to the intermediate transfer belt 4 by an electrostatic force, secondary transfer roller 7 provided opposingly to the stretching roller 3 and transferring secondary the toner images primary transferred on the intermediate transfer belt 4 to a recording paper P by an electrostatic force, and a fixing device 8 melting the toner image to fix onto the recording paper P by pressing and heating the recording paper P on which the toner image is transferred.

The image forming portions 5Y, 5M, 5C, 5K have respectively a photoconductor 9, a charger 10 charging the surface of the photoconductor 9, an exposure device 11 selectively exposing the charged photoconductor 9 to form an electrostatic latent image, a developing device 12 feeding toner to the electrostatic latent image formed on the photoconductor 9 to develop an image, and a cleaner 13 scraping off the toner which failed to be used in the primary transfer to the intermediate transfer belt and left on the photoconductor 9.

In the image forming apparatus 1, the primary transfer rollers 6Y, 6M, 6C, 6K are respectively sifted in the moving direction of the intermediate transfer belt 4 with reference to the opposing photoconductor 9 and pressed to the intermediate transfer belt 4 so that the intermediate transfer belt 4 is slightly deflected to stretched over the photoconductor 9. In this way, a nip in which the intermediate transfer belt 4 and the photoconductor 8 continuously pressure contact to each other is formed.

In the image forming apparatus 1, the primary transfer roller 6Y adjacent to the upstream stretch roller 2 is sifted in upstream side with reference to the opposing photoconductors 9 and the downstream primary transfer roller 6M, 6C, 6K are sifted in upstream side with reference to the opposing photoconductors 9. Further, in the image forming apparatus 1, the medial primary transfer rollers 6M, 6C are fixed in the positions at 5 mm downstream in the moving direction of the intermediate transfer belt 4 with reference to the respective photoconductors 9, but the primary transfer roller 6Y and the primary transfer roller 6K are provided movably in the moving direction of the intermediate transfer belt 4 with reference to the photoconductors 9.

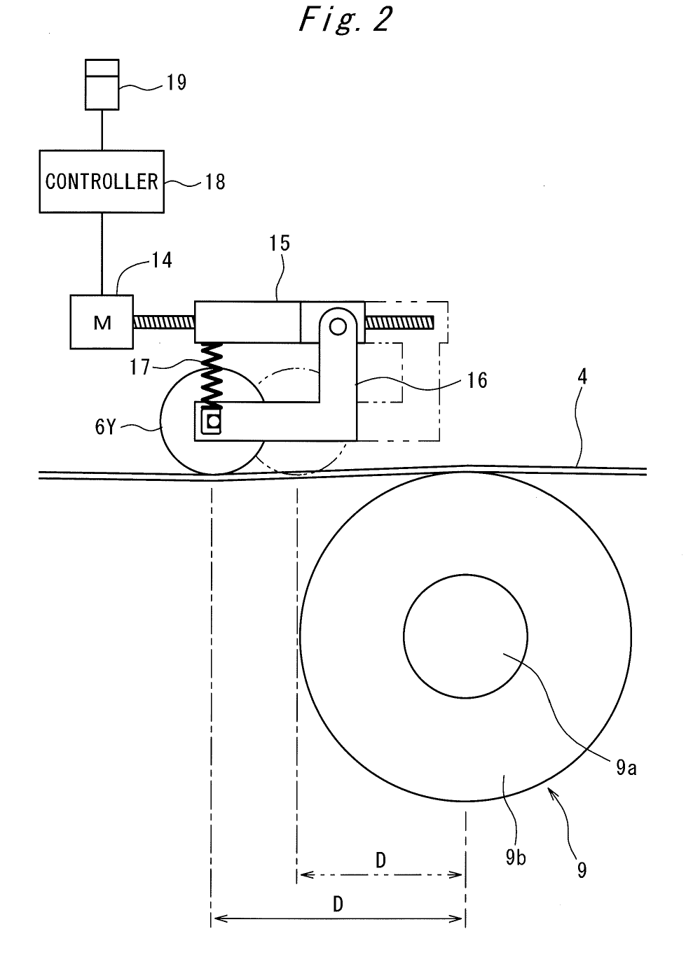

FIG. 2 shows the relationship between the primary transfer roller 6Y and the photoconductor 9 of the image forming portion 5Y in detail. The photoconductor 9 is provided a resin layer 9b formed on a surface of a metal core 9a, is supported in a position where the photoconductor 9 contacts to the intermediate transfer belt 4, and is rotationally driven. The primary transfer roller 6Y has a rotating shaft 6a which is supported by a supporting member 16 pivotably provided on a moving member 15 and which is biased by a coil spring 17 so as to move out toward the intermediate transfer belt 4 according to the swing of the supporting member 16, wherein the moving member 15 can be positioned back and force in the moving direction of the intermediate transfer belt 4 (horizontal direction) by motor 14.

The primary transfer roller 6Y is positioned, in its center position, at a shift amount D of upstream in the moving direction of the intermediate transfer belt 4 with reference to the photoconductor 9. This shift amount D can be adjusted by screw feeding of the movable member 15 with the motor 14. In this embodiment, the shift amount D can be adjusted in a range of from 4 mm to 5.3 mm. Further, the motor 14 is controlled by the controller 18. The controller 18 drives the motor 14 to vary the shift amount D in response to a detected value of the hygrothermo sensor 19.

Also the primary transfer roller 6K is supported by a similar configuration to the primary transfer roller 6Y excepting that the primary transfer roller 6K is arranged to be shifted in the downstream side with reference to the photoconductor 9. Therefore, the primary transfer roller 6K also can be moved in the moving direction of the intermediate transfer belt 4 and is varied in position by the controller 18.

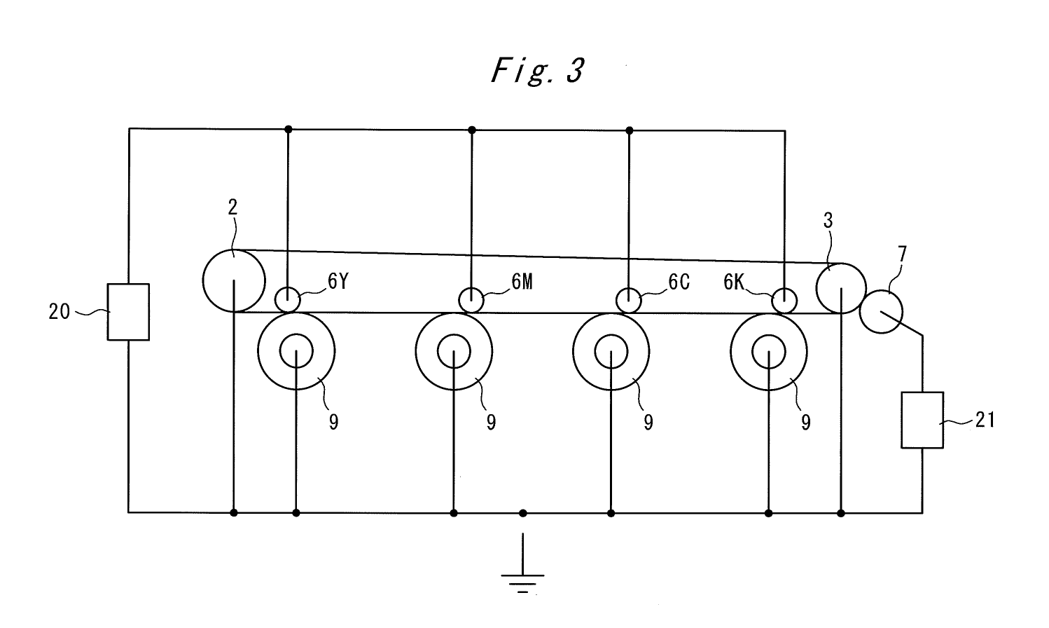

FIG. 3 shows the electrical configuration of the image forming apparatus 1. The stretch rollers 2, 3 are made from metallic material and grounded to prevent the intermediate transfer belt 4 from being charged. In case that the circumference of the stretch rollers 2, 3 are coated with a resin, carbon is dispersed into the elastic material such as EPDM to make its volume resistivity equal to or less than 1×10⁴ ohom·cm. The photoconductors 9 are respectively grounded at the metal cores 9a.

The primary transfer rollers 6Y, 6M, 6C, 6K are made from metal such as aluminum and steel and applied a predetermined voltage to ground (bias voltage relative to the photoconductor 9) by a primary transfer power source 20. The secondary transfer roller 7 is applied a predetermined voltage to ground (bias voltage relative to the stretch roller 3) by a secondary transfer power source 21. The primary transfer power source 20 and the secondary transfer power source 21 preferably can adjust the output voltage respectively to optimize transfers of image.

The intermediate transfer belt 4 which is made from polyphenylene sulfide resin with carbon dispersed in so as to adjust the surface resistivity within 1×10⁸−1×10¹² ohms/sq, preferably around 1×10⁹ ohms/sq is used so that the intermediate transfer belt 4 can be charged up by the primary transfer rollers 6Y, 6M, 6C, 6K or the secondary transfer roller 7. Alternatively, the intermediate transfer belt 4 may be made from resin material such as polycarbonate resin, polyimide resin, urethane resin, fluorinated resin, nylon resin and likes, or elastic material such as silicone rubber, urethane rubber and likes with dispersed conductive powder or carbon in to adjust its surface resistivity within the above described range.

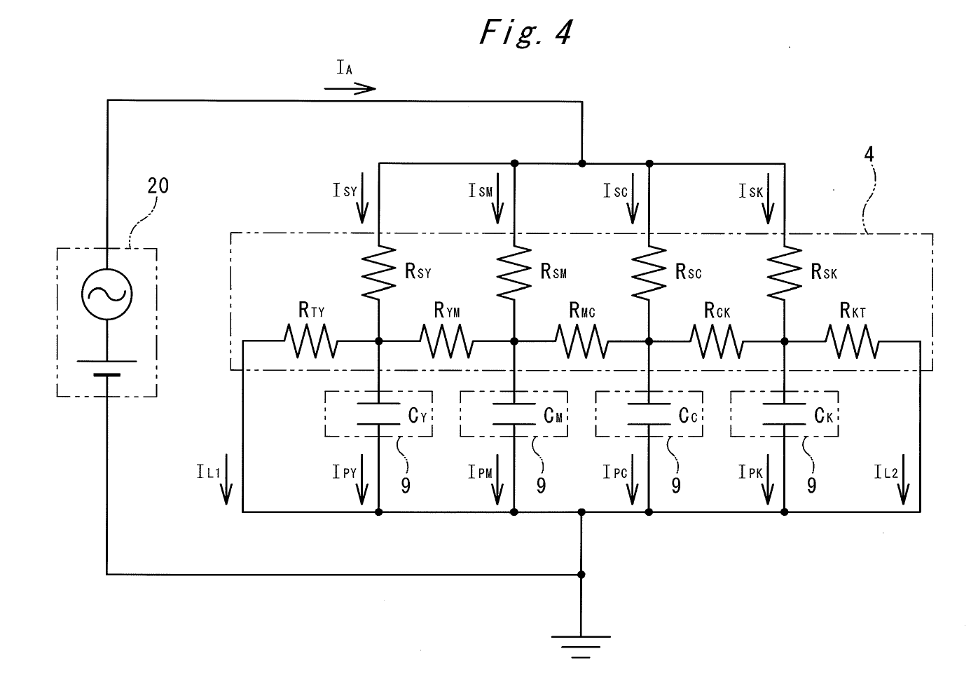

Furthermore, FIG. 4 shows an equivalent circuit diagram of the electrical configuration with respect to the primary transfer in the image forming apparatus 1. As shown in the figure, the photoconductors 9 of the image forming portions 5Y, 5M, 5C, 5K can be considered as capacitors C_{Y}, C_{M}, C_{C}, C_{K} which storage electric charge in the metal core. And, the intermediate transfer belt 4 can be considered as a resistive element of which resistance values between the stretch rollers 2, 3, the primary transfer rollers 6Y, 6M, 6C, 6K and the photoconductor 9 vary according to the contacting position of them to the intermediate transfer belt 4. In the figure, the resistance value of the intermediate transfer belt 4 between the primary transfer rollers 6Y, 6M, 6C, 6K and the opposing photoconductors 9 are respectively represented by R_{SY}, R_{SM}, R_{SC} R_{SK}, the resistance value of the intermediate transfer belt 4 between the stretch roller 2 and the photoconductor 9 of the image forming portion 5Y is represented by R_{TY} the resistance value of the intermediate transfer belt 4 between the photoconductor 9 of the image forming portion 5Y and the photoconductor 9 of the image forming portion 5M is represented by R_{YM}, the resistance value of the intermediate transfer belt 4 between the photoconductor 9 of the image forming portion 5M and the photoconductor 9 of the image forming portion 5C is represented by R_{MC}, the resistance value of the intermediate transfer belt 4 between the photoconductor 9 of the image forming portion 5C and the photoconductor 9 of the image forming portion 5K is represented by R_{CK}, and the resistance value of the intermediate transfer belt 4 between the photoconductor 9 of the image forming portion 5K and the stretch roller 3 is represented by R_{KT}.

Assuming that currents flowing from the primary transfer rollers 6Y, 6M, 6C, 6K is respectively I_{SY}, I_{SM}, I_{SC}, I_{SK}, total current I_{A} supplied from the primary transfer power source 18 is expressed by I_{A}=I_{SY}+I_{SM}+I_{SC}+I_{SK}. Assuming that transfer currents flowing in the photoconductors 9 of the image forming portions 5Y, 5M, 5C, 5K are respectively I_{PY}, I_{PM}, I_{PC}, I_{PK}, leaking current from the primary transfer roller 6Y to the stretch roller 2 is I_{L1}, and leaking current from the primary transfer roller 6K to the stretch roller 3 is I_{L2}, the currents I_{SY}, I_{SK}, can be expressed respectively by I_{SY}=I_{PY}+I_{L1}, I_{SK}=I_{PK}+I_{L2}.

The resistance value R_{TY} of the intermediate transfer belt 4 between the stretch roller 2 and the primary transfer roller 6Y and the resistance value R_{KT} of the intermediate transfer belt 4 between the primary transfer roller 6K and the stretch roller 3 respectively depend on the distance between the stretch roller 2 and the primary transfer roller 6Y and the distance between the primary transfer roller 6K and the stretch roller 3. Also the resistance values R_{SY}, R_{SM}, R_{SC}, R_{SK} between the primary transfer rollers 6Y, 6M, 6C, 6K and the respective opposing photoconductor 9 depend on the distances between the primary transfer rollers 6Y, 6M, 6C, 6K and the respective opposing photoconductor 9.

In this embodiment, transfer currents of the respective photoconductors 9 is preferably equal to each other (I_{PY}=I_{PM}=I_{PC}=I_{PK}) to equalize transfer forces for toner images from the photoconductors 9 to the intermediate transfer belt 4. If the shift amounts D of the primary transfer rollers 6Y and 6K with reference to the opposing photoconductors 9 are 5 mm equal to that of the primary transfer rollers 6M, 6C, it is recognized as R_{SY}=R_{SM}=R_{SC}=R_{SK}. Therefore, the transfer currents I_{PY}, I_{PK} in the photoconductors 9 of the image forming portions 5Y and 5K will be smaller than the transfer current I_{PM}, I_{PC} in the photoconductors 9 of the image forming portions 5M and 5C. In this case, if the shift amounts D of the primary transfer rollers 6Y and 6K are made smaller than the shift amount (5 mm) of the primary transfer rollers 6M, 6C, the resistance values R_{SY}, R_{SK} are reduced. Therefore, the impedances between the primary transfer rollers 6Y, 6K and metal cores 9a of the respective opposing photoconductors 9 are reduced, hence the transfer currents I_{PY}, I_{PK} increase. In this way, by respectively adjusting the shift amounts D of the primary transfer rollers 6Y and 6K, the current I_{L1}, I_{L2} leaking from the primary transfer rollers 6Y, 6K to the stretch rollers 2, 3 are compensated so as to equalize the transfer currents I_{PY}, I_{PM}, I_{PC}, I_{PK} in the photoconductors 9. Accordingly, a transfer defect is avoided and hence optimized primary transfer can be performed.

In this embodiment, in case that the distance between the primary transfer roller 6Y and the stretch roller 2 in moving direction of the intermediate transfer belt 4 (horizontal distance between centers) is 75 mm, in a normal environmental condition (temperature and humidity), when the shift amount D of the primary transfer roller 6Y is 4.5 mm, the transfer current I_{PY} in the photoconductor 9 of the image forming portion 5Y could be equal to the transfer currents I_{PM}, I_{PC} of the photoconductors 9 of the image forming portions 5M, 5C. And, in this embodiment, in case that the distance between the primary transfer roller 6Y and the stretch roller 2 in moving direction of the intermediate transfer belt 4 is 60 mm, it is required that the shift amount D of the primary transfer roller 6Y is 4.0 mm to make the transfer current I_{PY} in the photoconductor 9 of the image forming portion 5Y equal to the transfer currents I_{PM}, I_{PC} of the photoconductors 9 of the image forming portions 5M, 5C. Further, in case that the distance between the primary transfer roller 6Y and the stretch roller 2 in moving direction of the intermediate transfer belt 4 is more that 80 mm, even when the shift amount D of the primary transfer roller 6Y is 5.0 mm, the transfer current I_{PY} in the photoconductor 9 of the image forming portion 5Y has been equal to the transfer currents I_{PM}, I_{PC} of the photoconductors 9 of the image forming portions 5M, 5C.

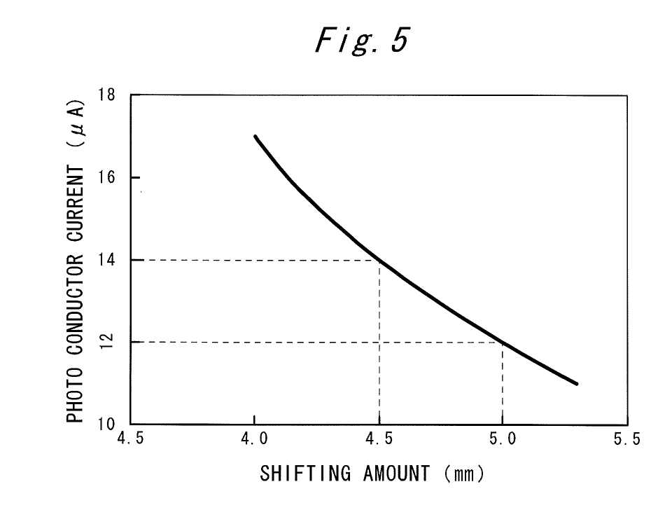

FIG. 5 shows a relationship between the shift amount D of the primary transfer roller 6Y and the transfer current flowing through the opposing photoconductor 9 in the image forming apparatus in a normal environmental condition. If the shift amounts D of the primary transfer rollers 6M, 6C are 5 mm and the transfer currents I_{PM}, I_{PC} in the opposing photoconductors 9 are 14 μA, the shift amount D of the primary transfer roller 6Y adjacent to the stretch roller 2 should be 4.5 mm which is smaller than the shift amounts D of the primary transfer rollers 6M, 6C. Similarly, the shift amount D of the primary transfer roller 6K adjacent to the stretch roller 3 should be smaller than the shift amounts D of the primary transfer rollers 6M, 6C to compensate the current I_{L1} leaking to the stretch roller.

When the environmental condition (temperature and humidity) where the image forming apparatus is used has been changed, the resistivity of the intermediate transfer belt 4 varies so that the appropriate shift amount D of the primary transfer roller 6Y, 6K are also changed. In the image forming apparatus 1, the controller 18 varies the shift amount D in response to the detected value of the hygrothermo sensor 19. In the image forming apparatus 1 under a high temperature and high humidity condition, the shift amount D is reduced about 0.5 mm with reference to that under the normal condition.

In the image forming apparatus as this embodiment, in case that the surface resistivity of the intermediate transfer belt 4 is 1×10⁸ ohms/sq, if the horizontal distance between the primary transfer roller 6Y and the stretch roller 2 is 75 mm, the transfer current I_{PY} comes to be substantially equal to the transfer current I_{PM}, I_{PC} when the shift amount D of the primary transfer roller 6Y is 4.0 mm in a normal environmental condition. And in case that the surface resistivity of the intermediate transfer belt 4 is 1×10¹² ohms/sq, the transfer current I_{PY} comes to be substantially equal to the transfer current I_{PM}, I_{PC} when the shift amount D of the primary transfer roller 6Y is 4.8 mm.

In case of the primary transfer rollers 6Y, 6M, 6C, 6K are coated with a conductive elastic material in this embodiment, the electrical resistances of the primary transfer rollers 6Y, 6M, 6C, 6K should be less than 5×10⁸ ohms as sufficiently lower than the resistance components of the intermediate transfer belt 4. Notably, these resistance values are measured by laying the primary transfer rollers 6Y, 6M, 6C, 6K on a conductive body such as a cupper plate and then by metering electrical resistances between the cupper plate and the metal cores of the primary transfer rollers 6Y, 6M, 6C, 6K respectively.

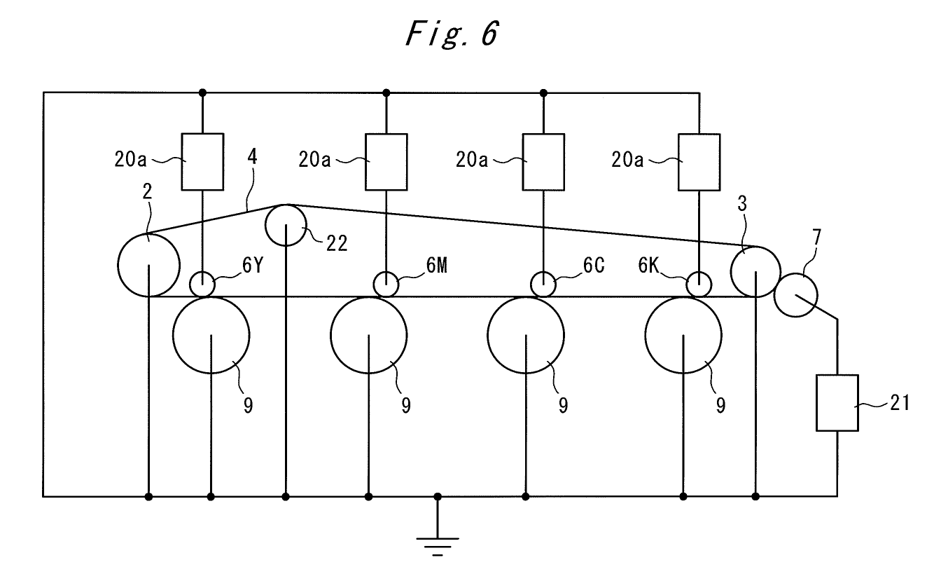

FIG. 6 shows a configuration of a image forming apparatus 1a as second embodiment of the present invention. It is to be noted that in this embodiment, components identical to those in the first embodiment are designated by identical reference numerals to omit redundant explanation.

In this image forming apparatus 1a, the primary transfer rollers 6Y, 6M, 6C, 6K are held so that the shift amounts D can be manually adjusted individually. Further, the image forming apparatus 1a has four independent primary transfer power sources 20a respectively connected to the primary transfer rollers 6Y, 6M, 6C, 6K. This primary transfer power source 20a has a simple configuration which does not have a function to adjust its output voltage.

In the image forming apparatus 1a as this embodiment, the transfer currents I_{PY}, I_{PM}, I_{PC}, I_{PK} can be unbalanced due to not only the leaking current I_{L1}, I_{L2} from the primary transfer rollers 6Y, 6K to the stretch rollers 2, 3 but also individual difference in the output voltages of the primary transfer power sources 20a. In this embodiment, the transfer currents I_{PY}, I_{PM}, I_{PC}, I_{PK} in the photoconductors 9 are equally adjusted by individually adjusting the shift amounts D of the primary transfer rollers 6Y, 6M, 6C, 6K, prior to the shipment of the image forming apparatus 1a. Also in this embodiment, the shift amounts D of the primary transfer rollers 6Y, 6K should be smaller than the shift amounts D of the primary transfer rollers 6M, 6C.

Further, the image forming apparatus 1a has a third stretch roller 22 to apply a tension to the intermediate transfer belt 4. The leaking current I_{L1}, I_{L2} depend on the resistance between the primary transfer rollers 6Y, 6K and stretch rollers 2, 3 which is adjacent to the primary transfer rollers 6Y, 6K. Therefore, existence of the stretch roller 22 does not affect application of the present invention. While the stretch roller 3 opposes to the secondary transfer roller 7 to form a nip in this embodiment, the stretch roller 22 which is not adjacent to the primary transfer roller 6Y, 6K may oppose the secondary transfer roller 7.

The present invention is to prevent a transfer defect due to the leaking current I_{L1}, I_{L2} caused by arranging the stretch rollers 2, 3 in proximity to the primary transfer rollers 6Y, 6K with downsizing of the image forming apparatus 1a. It is possible to make the stretch rollers 2, 3 nonconductive to discharge the electric charge in the intermediate transfer belt 4 to the ground thorough an extra component. However, the stretch roller 3 opposing to the secondary transfer roller 7 has to be grounded to be a reference of the secondary transfer voltage. Accordingly, a reduction of the shift amount D of the primary transfer roller 6K which is adjacent to the stretch roller 3 to which the secondary transfer roller 7 is opposing expressly enhances the downsizing of the image forming apparatus 1.

As described above, according to the present invention, there is provided an image forming apparatus comprising an intermediate transfer belt in a form of endless loop stretched over a plurality of stretch roller to move around, a plurality of photo conductors aligned along the intermediate transfer belt, a plurality of primary transfer rollers which respectively opposes to the photoconductors and is pressed against the photoconductor with interposition of the intermediate transfer belt to form a nip, and a power source for applying a voltage to the primary transfer rollers, wherein the primary transfer rollers are arranged to be shifted with reference to the photoconductors in the moving direction of the intermediate transfer belt, and a shifted amount of at least one of the primary transfer rollers with reference to the photoconductor is different from that of another primary transfer roller with reference to the respective photoconductors.

According to this configuration, the impedance between the primary transfer roller and the photoconductor is smaller as the shift amount of the primary transfer roller with reference to the photoconductor is smaller. This can coordinate transfer currents flowing through the respective photoconductors so as to eliminate any transfer defect.

In the image forming apparatus according to the present invention, a shifted amount of the primary transfer roller adjacent to the stretch roller with reference to the photoconductor may be different from that of another primary transfer roller with reference to the photoconductor.

According to this configuration, from the primary transfer roller adjacent to the stretch roller, an electric current leaks out through the intermediate transfer belt to the stretch roller. Therefore, by reducing the shift amount of the primary transfer roller adjacent to the stretch roller to decrease the impedance, an electric current larger by the amount of the leaking current is supplied to the primary transfer roller adjacent to the stretch roller. Consequently, the transfer current of to the primary transfer roller adjacent to the stretch roller can be adjusted as same as the other primary transfer rollers.

In the image forming apparatus according to the present invention, at least one of the stretch rollers to which the primary transfer roller is adjacent may oppose to a secondary transfer roller.

According to this configuration, because the stretch roller opposing to the secondary transfer roller is grounded to ensure the secondary transfer, it is highly possible to that a current leaks out from the adjacent primary transfer roller. Therefore, it is preferable that the shift amount of the primary transfer roller which is adjacent to the stretch roller opposing to the secondary transfer roller is reduced to compensate the leaking current.

In the image forming apparatus according to the present invention, the shifted amount of the primary transfer roller adjacent to the stretch roller with reference to the photoconductor may be varied depending on at least one of an environmental condition and an operation speed of the image forming apparatus.

According to this configuration, a variance due to an environment and an operation speed in the resistivity of the intermediate transfer belt and the like can be compensated by the adjustment of the shift amount of the primary transfer roller with reference to the photoconductor.

In case that the intermediate transfer belt have a surface resistivity of 1×10⁸−1×10¹² ohms/sq, the present invention is particularly advantageous when the distance between the stretch roller and the primary transfer roller in the moving direction of the intermediate transfer roller preferably is equal to or less than 80 mm.

And the present invention is particularly advantageous when the primary transfer roller has a resistance between its surface and its metal core equal to or less than 5×10⁶ ohms.

Further, in the image forming apparatus according to the present invention, all of the primary transfer rollers may be connected to the power source in parallel. Alternatively, the power sources may be independently provided one each for the primary transfer rollers, and the output voltage of the power sources may be fixed.

As described above, according to the present invention, the impedance between the primary transfer roller and the photoconductor is adjusted in accordance with the shift amount of the primary transfer roller with reference to the photoconductor to compensated the current leaking thorough the intermediate transfer belt out to the stretch roller. Therefore, the transfer current flowing through the each photoconductor is regulated, and hence a transfer defect is eliminated.

Although the present invention has been fully described in connection with the preferred embodiment thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image forming apparatus comprising
an intermediate transfer belt in a form of endless loop stretched over a plurality of stretch roller to move around,
a plurality of photo conductors aligned along the intermediate transfer belt,
a plurality of primary transfer rollers which respectively opposes to the photoconductors and is pressed against the photoconductor with interposition of the intermediate transfer belt to form a nip, and
a power source for applying a voltage to the primary transfer rollers, wherein
the primary transfer rollers are arranged to be shifted with reference to the photoconductors in the moving direction of the intermediate transfer belt, and
a shifted amount of at least one of the primary transfer rollers with reference to the photoconductor is different from that of another primary transfer roller with reference to the respective photoconductors.

2. The image forming apparatus according to the claim 1, wherein a shifted amount of the primary transfer roller adjacent to the stretch roller with reference to the photoconductor is different from that of another primary transfer roller with reference to the photoconductor.

3. The image forming apparatus according to the claim 2, wherein at least one of the stretch rollers to which the primary transfer roller is adjacent opposes to a secondary transfer roller.

4. The image forming apparatus according to the claim 2, wherein the shifted amount of the primary transfer roller adjacent to the stretch roller with reference to the photoconductor is varied depending on at least one of an environmental condition and an operation speed of the image forming apparatus.

5. The image forming apparatus according to the claim 1, wherein the intermediate transfer belt has a surface resistivity of 1×10⁸−1×10¹² ohms/sq, and the distance between the stretch roller and the primary transfer roller in the moving direction of the intermediate transfer roller is equal to or less than 80 mm.

6. The image forming apparatus according to the claim 1, wherein the primary transfer roller has a resistance between its surface and its metal core equal to or less than 5×10⁶ ohms.

7. The image forming apparatus according to the claim 1, wherein all of the primary transfer rollers are connected to the power source in parallel.

8. The image forming apparatus according to the claim 1, wherein the power sources are independently provided one each for the primary transfer rollers, and the output voltage of the power sources are fixed.
